(19) United States
(12) Patent Application Publication
(10) Pub. No.: US 2006/0232095 A1
(43) Pub. Date: Oct. 19, 2006

(54) Retractable roll-up cover

(76) Inventor: Marty Sedighzadeh, Littleton, CO (US)

Correspondence Address: Marty Sedig, 11504 W Berry Place, Littleton, CO, 80127, US

(21) Appl. No.: 11/343,566

(22) Filed: Jan. 31, 2006

Related U.S. Application Data
(60) Provisional application No. 60/670,621, filed on Apr. 13, 2005.
(60) Provisional application No. 60/697,293, filed on Jul. 8, 2005.

(51) Int. Cl. B60J 11/00

(52) U.S. Cl. 296/98

(57) ABSTRACT

A cover system for motor vehicles and other items is described. In one embodiment, the cover system includes a fabric folded in a predetermined manner wound around a roller that is contained in a housing. A front end of the fabric cover is mounted to a guide bar that includes means for securing the guide bar in place when the cover is deployed. In preferred variations, a tubular motor is utilized to facilitate rolling and unrolling of the cover. When used with motor vehicles, the cover system can be mounted in the trunk of the motor vehicle.

### RELATED APPLICATIONS

This application claims priority to provisional applications Nos. 60/670621 filed on Apr. 13, 2005 and 60/697293 filed on Jul. 8, 2005 having the same inventor as this application. Both provisional patents are incorporated herein in their entirety by reference.

### FILED OF THE INVENTION

This invention relates generally to fabric covers and fabric cover systems.

### BACKGROUND OF THE INVENTION

Many types of car covers are known from fabric covers to padded covers and even covers having rigid sections. Fabric covers are the most common and also the least expensive. They are typically stored in a bag or uncontained in a trunk or cargo section of a vehicle. The time required to install a fabric cover is compounded by having to remove the cover from the bag and determine the covers proper orientation before installing it. Additionally, removal time is increased by the need to pack the cover in an associated bag or box. Because it can be difficult to install or remove such a cover in windy or rainy conditions, the cover cannot practically be folded to its most compact size. Accordingly, a fabric cover can end up taking up significant space in a trunk and is often not very tidy. The end result with these types of covers is that the user and the cover get dirty using them and installation and removal is time consuming.

Foam covers take up even more space and are even more time consuming to install or remove. And hard covers are typically the worst of the bunch taking the most time to install or remove and often using substantially all of the storage space in a vehicle.

Because of the general nature of typical car covers, after a period immediately following the purchase of the cover, the frequency of cover use decreases for all but the most fastidious car cover owners. Eventually, the use of cargo space in the vehicle becomes a greater consideration than the keeping a car clean or shielding the paint from the sun's rays and the cover is relegated to storage spot in a corner of the garage or deep in a closet rarely if ever to be used again.

Several types of car cover systems have been proposed that allegedly speed up the installation and removal of the cover using one or more motors or biasing mechanisms. The typical prior art motorized cover devices mount in locations on the vehicle, such as underneath a bumper, which expose the device to road debris, water and mud infiltration. Others require the device to be stationed or mounted to the top of the car, which can be unsightly. Further, some require the mounting of tracks and/or rigging to the vehicle at various locations to facilitate deployment and retraction of a car cover.

Other car cover devices are stored in the vehicle until they are to be used and then they must be removed from the vehicle and placed on and even temporarily secured to the vehicle. While some of these designs offer more compact storage and easier deployment and removal, they suffer from the same deterrent as traditional car covers in that the user is still required to make a significant effort to remove the cover device from the car and position it in place for use. This additional operation requiring removal from the interior of a vehicle and repositioning can often make the difference between whether a user deploys his/her cover or doesn't use it at all.

Ultimately, the key consideration to regular and consistent use of a vehicle cover is ease of use in terms of (i) the time required for deploying and removing the cover, and (ii) the perceived or real effort required to deploy and remove a cover. Additionally, cleanliness of both the cover and the user) and the amount of cargo space taken up by the cover are of critical importance.

### BRIEF DESCRIPTION OF THE DRAWINGS

FIG. 1 is an isometric illustration of a vehicle cover system according to one embodiment of the present invention.

FIG. 2 is an exploded view of the vehicle cover system shown in FIG. 1 according to one embodiment of the present invention.

FIG. 3 is isometric view of partially unfolded cover fabric according to one embodiment of the present invention.

FIG. 4A-E show the vehicle cover system at various points during its deployment on an associated vehicle according to one embodiment of the present invention.

FIG. 5 is an isometric illustration of an automobile covered with another embodiment vehicle cover system designed primarily to cover the windowed surfaces of the automobile, its roof and shield the interior from the rays of the sun.

FIG. 6 is an isometric illustration of a manually operated vehicle cover system configured for use on a motorcycle or scooter according to another embodiment.

FIG. 7 is an exploded isometric illustration of a first crank arm assembly according to one embodiment of the invention.

FIG. 8 is an exploded isometric illustration of a second crank arm assembly according to one embodiment of the invention.

FIG. 9 is an illustration of a partially deployed vehicle cover system that utilizes a motorized cable system to deploy and retract the fabric cover according to yet another embodiment of the present invention.

FIG. 10 is an illustration of a cover system for covering a barbecue grill according to one embodiment of the present invention.

FIG. 11 is an illustration of the cover system of FIG. 10 with the fabric cover deployed over a barbecue grill according to one embodiment of the present invention.

### DETAILED DESCRIPTION

Various embodiments of full and partial vehicle cover systems are described that ameliorate many of the disadvantages of prior art covers and cover systems. In a first embodiment, a cover system is described for substantially covering the entirety of the vehicle's exterior. Typically, the system is fully contained and securely mounted within a trunk or the unit can be built into the rear bumpers as an OEM option in new vehicles, both permitting access for the traveling fabric and its Guide-Bar from inside the trunk of a vehicle with (i) the cover fabric itself neatly rolled upon an external surface of a tubular motor, and (ii) the combination of the motor and fabric cover substantially enclosed within a cylindrical housing. At least a portion of a leading edge of the cover fabric is secured to a guide-bar assembly that is held by the user during deployment and retraction to guide the cover over the length of the vehicle. The guide-bar also preferably includes hooks on either of its longitudinal ends that can be secured to the front of the vehicle, such as under bumper or spoiler. A control device with buttons or other suitable switches such as buttons for (reverse, stop & forward movement of the cover is provided on the guide-bar (or independently) to control the rotational direction of motor movement. In certain variations, the remote is removable from the guide-bar and/or is in wireless communication with a motor controller.

To deploy the first embodiment cover, a user first opens the trunk of the vehicle and depresses the unroll (or forward) button on the guide-bar control while feeding the guide-bar and the cover through the gap formed between the front edge of the trunk and rear windshield of the vehicle. Once through the gap, the user then guides the cover forwardly using the guide-bar while depressing the unroll (or forward) button. Once unrolled sufficiently so that the guide-bar is located proximate or just below the front bumper of the vehicle, the user typically secures the guide-bar to the vehicle using the provided hooks. In preferred embodiments, the cover system's controller is set to stop the cover fabric automatically, or alternatively, the user may manually to the unrolling by pushing the stop button. To facilitate easier attachment in some variations the hooks may be coupled to a spring, an elastic rope, such as a bungee cord, or another biasing means. Next, the user shuts the trunk, and then the user unfolds the back portion of the fabric to cover the top surfaces of the vehicle's trunk as well as the rear bumper. Next, the user unfolds the sides of the cover by releasing hook and loop patches on the cover fabric and pulling the sides downwardly. Optionally, the user then tightens a cord that is thread along or proximate the bottom perimeter edge of the cover to tighten the bottom perimeter edge, or vicinity thereof, of the cover against the vehicle reducing the likelihood that the sides of the cover could blow up and off when subjected to windy conditions.

To retract the cover, the user first loosens the perimeter cord (or draw string), folds the side and then rear sections upwardly, and secures the sections at the hook and loop patches. Next, the user opens the trunk and releases the guide-bar hooks. Next, the user depresses the retract (or reverse) button to cause the tubular motor to wind the cover into its container thereon. As the cover is retracting, the user guides it along using the guide-bar. Once the hood gap is reached, the guide-bar is thread through it and the cover is retracted until the guide-bar is in contact with and generally covers a corresponding slot in the cylindrical housing and the cover fabric preferably being under tension. Finally, the user closes the trunk.

In a second embodiment, the cover fabric is sized only to cover the top (or roof) and windowed surfaces of a sedan and not the trunk, the hood, the fenders and the doors. It primarily serves to keep the interior of a vehicle relatively cool when the vehicle is parked in the sun. This cover is installed in substantially the same manner as the first embodiment, although in some variations, the cover fabric is manually unrolled from a rotating shaft in the cylindrical housing and retracted back into the housing using a crank mounted to the housing. In other variations, the cover system can be motorized in a similar manner as the first embodiment. Magnets, hooks (attached to front & back fender wheel wells on both sides of the vehicle), suction cups or other attachments means are typically provided proximate the covers perimeter to secure it in place and prevent it from being blown off in wind.

A third variation comprises a cover system designed to cover a motorcycle. Typically, this embodiment operates in a similar manner as the first embodiment alternatively a manual version can be provided for unrolling and retracting the cover. Concerning the manually operative variations, the cover is unrolled by pulling the guide-bar forwardly after a locking crank arm is released to permit the roller contained in the cylindrical housing to rotate. Once the cover is unfolded over the bike, a cord or drawstring threaded around the covers bottom perimeter is tightened to hold the cover in place. Retraction of the cover is facilitated by turning the manual hand crank (or motorized) to pull the cover fabric into the housing.

The cylindrical housing of this embodiment is usually mounted to or at the license plate mounting bracket (which exists on substantially all road-ready motorcycles). The license plate mounting bracket is often mounted to a rear fender but in other motorcycles it can be mounted to other locations such as a frame member located behind the seat. The third embodiment cover system does not interfere with normal operation of the bike when the cover is stowed. In preferred variations of all embodiments, including the third embodiment, the cover systems can be detached from their mounting location by loosening two thumb screws permitting the user to store the system elsewhere.

A fourth embodiment is contemplated wherein the cover system is offered as an OEM option or included accessory with the vehicle and includes motors mounted in the front bumper that are attached to spools which wind or unwind cables that are coupled with a guide-bar assembly such that the cover can be automatically deployed using a remote without a user having to open the trunk or guide the guide-bar. The tubular motor within the cover system housing is also provided to facilitate cover fabric retraction. Ideally, recessed tracks in the vehicle's body, such as plastic rain gutters that presently exists in most new vehicles, are provided to contain the cables.

Although the described embodiments pertain primarily to automobiles and motorcycles, it is appreciated that variations and other embodiments are contemplated for use with other types of motor vehicles, such as trucks and their associated trailers. Further, embodiments can be used in conjunction with other items such as but not limited to: bicycles; outdoor air conditioning units; barbeque grills and evaporative cooler units.

The above embodiments offer one or more advantages over prior art covers and cover systems. First, they provide compact and out of the way storage for the cover fabric. For instance, certain variations of the automotive covers are mounted on the roof portion or to the lid of a vehicle's trunk, and as such it is unlikely to interfere with the normal types of packages carried in a car trunk on a day-to-day basis. In one variation of the first embodiment, the cylindrical housing takes up about ⅓ of a cubic foot of trunk space, and a variation of the second embodiment takes up about ¼ of a cubic foot. Another advantage is the relative ease of use of the embodiments both in time required to deploy and retract the cover, as well as, the simple easily remembered repeatable process used to deploy and retract the cover. Ultimately, the compactness of the embodiments coupled with their ease of use and cleanliness (pertaining to both the fabric and the user) are superior to prior art covers and cover systems.

Embodiments other than the four embodiments briefly described above are also contemplated as would be obvious to one of ordinary skill in the art given the benefit of this disclosure. For instance, any one of the first three embodiments mentioned above could be either motorized or be completely manually operated.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “one variation”, “a variation” and similar phrases mean that a particular feature, structure, or characteristic described in connection with the embodiment or variation is included in at least an embodiment or variation of the invention. The phrase “in one embodiment”, “in one variation” or similar phrases as used in various places in the specification are not necessarily meant to refer to the same embodiment or the same variation.

The term “couple” or “coupled” as used in this specification and the appended claims refers to either an indirect or direct connection between the identified elements, components or objects. Often the manner of the coupling will be related specifically to the manner in which the two coupled elements interact.

The term “tubular motor” as used herein refers to any electric motor, DC or AC, wherein the motors windings are contained in a tube that rotates when the power is provided to the motor. In other words, a tubular motor does not have a traditional rotational shaft as with conventional electric motors, rather the tube serves the same purpose as the shaft and rotates. Often gearing may also be contained within the tube. Tubular motors offer high torque capacity than traditional electric motors used to rotate elongated rods or cylinders. Furthermore, they are typically designed to operate at very low RPM compared to traditional shaft driven motors.

The terms “rope”, “cord”, “cable”, and “string” as one or more are used herein and in the claims are to be considered synonymous.

The term “fabric” as used herein and in the claims pertains to any flexible and thin sheet material that can be utilized to cover a car whether the “fabric” comprises a film, or is woven or nonwoven.

A First Embodiment Vehicle Cover System

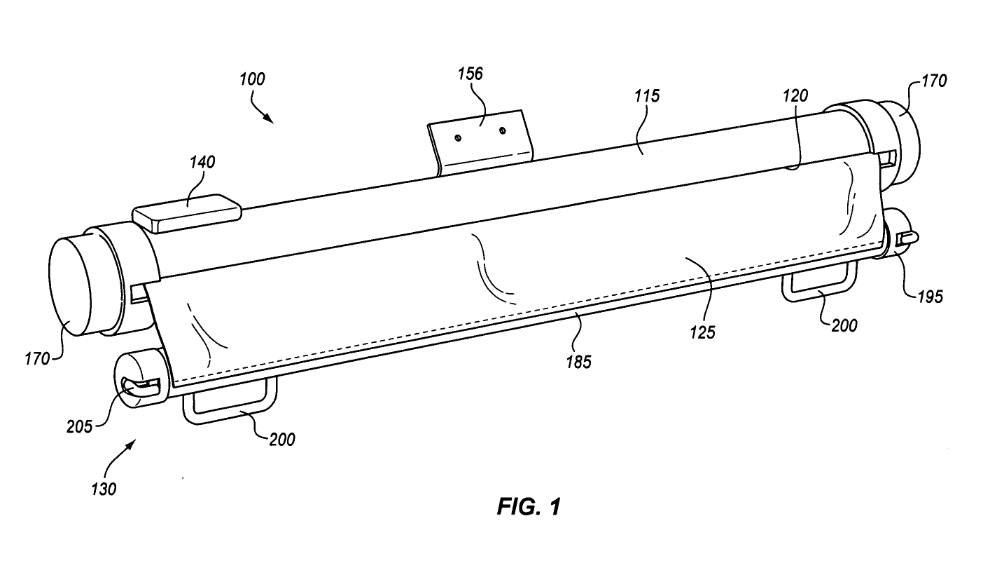

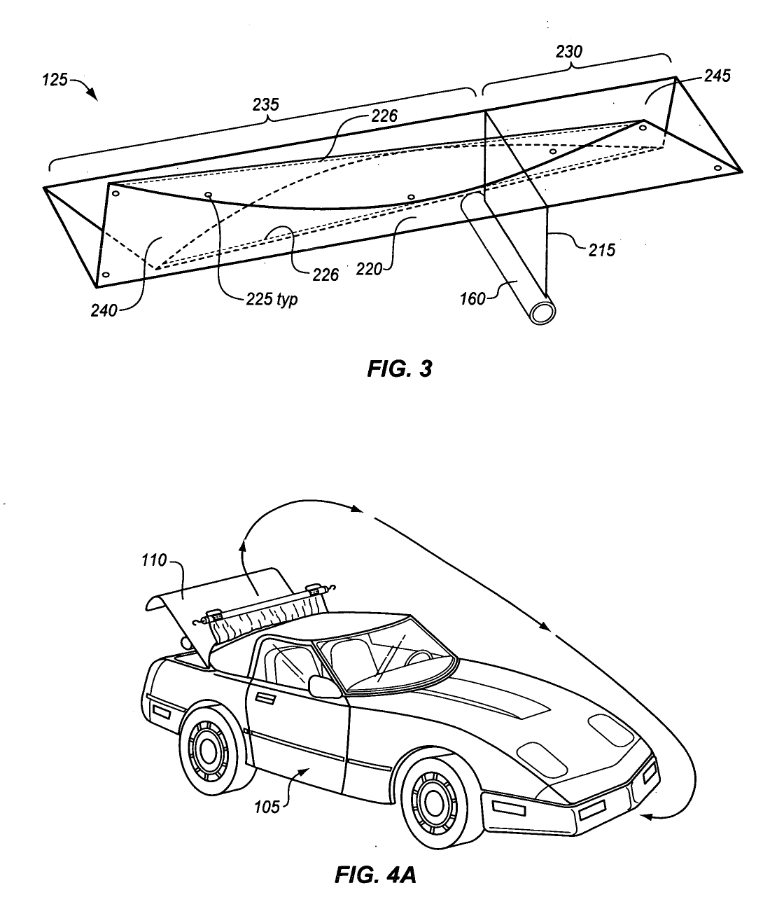

FIGS. 1 & 2 are depictions of a first embodiment cover system 100 designed for mounting in anywhere in the trunk of a sedan 105 (see FIG. 3A-E). For instance, the cover system can be mounted to the ceiling of the trunk lid 110 (see FIG. 3A-E) proximate the front edge of the lid. Other variations of the first embodiment are contemplated wherein the system is designed for incorporation into the bumper of new vehicles as an OEM option. The cover system takes up minimal volume in the trunk (about only 500 cubic inches for a typical system). And where the cover system is mounted up against the ceiling of a lid, the trunk volume taken up by the cover system is volume rarely utilized when transporting items in a trunk. While the system is typically utilized with a sedan, variations can be mounted to hatchbacks and wagons.

The first embodiment comprises a tubular generally (although not necessarily) cylindrical housing 115 that has a slit 120 extending longitudinally along the housing through which the fabric cover 125 is unrolled or retracted. The housing is typically comprised of plastic tubing although in variations the housing could be comprised of other suitable materials such as a metal. When the cover is fully retracted, the remainder of the cover system 100 is substantially contained within the housing save for a guide-bar assembly 130, a vehicle mounting bracket 156, and in certain variations a wireless receiver/controller 140. It is appreciated that variations of the cover system are possible without the use of a housing.

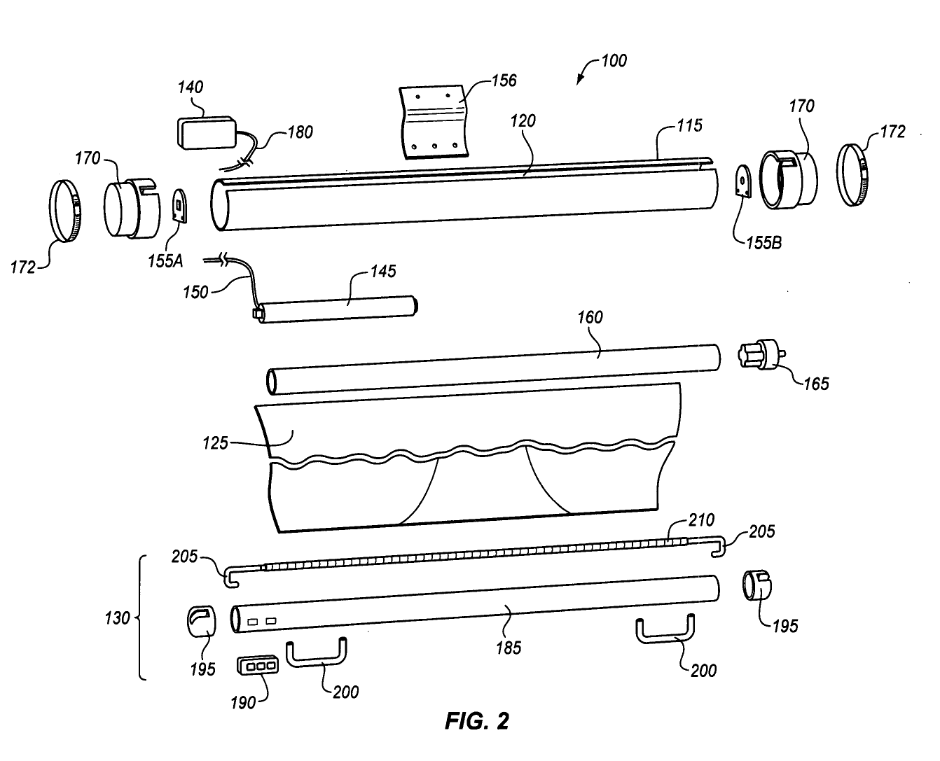

The vehicle mounting bracket as illustrated in FIGS. 1 & 2 is mounted to the housing 115 at the approximate middle thereof. It is typically bolted or riveted to the housing and includes a flange that extends outwardly of the housing with two or more fastener holes. The fastener holes are used to mount the cover system 100 to threaded studs attached to an associated vehicle in its trunk. If wing nuts are utilized, a user can easily remove the cover system from the trunk with minimal effort. Of course, other means of mounting the cover system, to a vehicle are contemplated, such as brackets located at either end of the housing, or one or more large hose clamps 172 that pass through slots in the trunk metal liner as shown as options in FIG. 2).

A low RPM tubular motor 145 is contained substantially within the housing 115 with a plurality of electrical wires 150 for powering and controlling the motor emanating from one of two ends of the motor. The motor can be DC or AC powered; however, when an AC motor is utilized, the system will further include a transformer and appropriate inverter to convert the DC current from a car battery to higher voltage AC current. Typically, at least one end of the motor is non-rotational relative to the motor's tube portion. This non-rotational end is securely coupled to a first mounting bracket 155A and the first mounting bracket is typically secured to an associated end cover 170.

In at least one variation, the length of the tubular motor is less than the length of the housing and/or the width of the fabric cover 125 when folded. Accordingly, an aluminum tube roller 160 that is typically 38″-60″ long is provided which is slid over and secured to the rotational tube portion of the tubular motor to rotate in concert with the tubular motor. The distal end of the roller is rotatably secured to a second mounting bracket 155B at a second end of the cover system typically by way of an end cap 165 that is received in the distal end of the tube and has a short axial shaft extending from it. The second mounting bracket received the axial shaft in a corresponding hole permitting the roller to rotate relative to the second mounting bracket. The second mounting bracket is secured to the associated end cover. Of course in variations, the roller can be dispensed with entirely and a tubular motor that spans the distance between the mounting brackets can be utilized. Further, a roller made of plastic, composite or other suitable material can be utilized in place of an aluminum tube.

One end of the folded fabric cover 125 is secured to the roller 160 as described below. Since the entire fabric cover is rolled up on the roller, the diameter of the roller must be sufficiently less than the diameter of the cylindrical housing so that sufficient space exists between the outer surface of the roller and the inner surface of the housing 115 to contain the fabric cover. In one variation of the first embodiment, the diameter of the cylindrical housing is about 3-5″.

Because a tubular motor 145 is utilized in the preferred embodiments and variations that contains the majority of the operational components of the motor within the rotational tube portion, the length of the tube portion with or without a tubular roller can be longer than a cover system using a conventional motor and associated gearing wherein the potential length of any roller upon which the fabric cover 125 can be wound is obviously reduced by the length of the conventional motor. Accordingly, the fabric cover of the present embodiments and variations need not be folded as much and space between the roller and the housing is suitably reduced providing a more compact and less obtrusive system.

The end caps 170 are typically slidably engaged over the respective ends of the housing 115 in such a manner as to prevent rotation of the end caps relative to the housing. Additionally, the end caps complete the enclosure of the cover fabric.

The wireless receiver/controller 140 is operatively coupled with the motor and a power source typically by way of electrical wires 180. In preferred variations, the wires are routed through a trunk-actuated switch that is normally open when the trunk is closed. Accordingly, the cover system is only powered when the trunk is open.

As illustrated in FIG. 2, the receiver 140 is physically located on the outside of the cylindrical housing but in other variations, the receiver may be located inside the housing, any where with in the vehicle's body or even incorporated to be part of the tubular motor 145. The actual radio or electromagnetic frequency utilized by the receiver and a corresponding remote control 190, as described in greater detail below, can vary but typically a range of no more than 15-20 feet is required.

The guide-bar assembly 130 is attached to a front end of the fabric cover 125 and when the cover is in its fully retracted position it rests against the longitudinal slot 120 in the cylindrical housing 115. The guide-bar assembly typically comprises a hollow elongated rod 185 to which the cover is attached by any suitable means including but not limited to mechanical fastening, adhesive bonding and adhesive taping. The rod is typically comprised of plastic but other suitable materials can be used such as metal, composites and wood can be utilized. Further, the rod need not be hollow in all variations of the cover system. The guide-bar may be covered in a soft pliable material, such as neoprene foam, to minimize the likelihood that the guide-bar assembly would scratch the paint job of the associated vehicle when the cover is being deployed or retracted.

The wireless remove control 190 is typically coupled and/or secured to the guide-bar 185 near one end thereof to facilitate the operation of the motor when unrolling or retracting the fabric cover. The remote includes switches/buttons for retracting the cover, unrolling the cover, and turning off the motor; however, the number of switches and their operational configuration can vary. As illustrated, the remote is attached to the guide-bar using hook and loop material and accordingly, the remote can be removed from the rod when desired by a user. In other variations, the remote may be more permanently affixed or integrated into the guide-bar assembly 130. In yet other variations, the wireless receiver and remote can be completely dispensed with and replaced by hard-wired control switches, such as located in the trunk of an associated vehicle. Alternatively, the wires can extend along the fabric cover from the motor to control switches on the guide-bar assembly.

One or more handles 200 can also be included on one or both ends of the bar 185 (for right or let handed individuals) to provide a user with something to hold while guiding the fabric cover 125 from its retracted and unrolled configurations. However, in some variations no handles are provided and a user grabs and holds the bar directly. The handles can be integrally molded into the bar or they can be attached to the bar using mechanical fasteners, thermoplastic fusion, adhesive bonding or other suitable means.

A pair of hooks 205 emanate from each end of the hollow guide bar 185 that are coupled by a bungee cord 210 (or spring) that extends through the interior of the guide bar. Operationally, the hooks permit the used to secure the guide-bar assembly 130 and the front of the fabric cover 125 to the front of a vehicle typically underneath its front bumper (or spoiler). In variations, other attachment means can be utilized in place of or in addition to the hooks. For instance, bracketry could be provided that is secured to the underside of an associated vehicle's bumper and that mate with corresponding bracketry on the guide-bar assembly. Further, the manner in which the hooks couple with the guide-bar assembly can vary as well. For instance, other types of biasing mechanisms, such as one or more springs, can be used in place of the bungee cord, or the biasing mechanisms can be replaced with mechanical adjusters, such as threaded rods and corresponding threaded receiving nuts to provide adjustment or mechanical quick release connectors. To cover the ends of the rod 185 one or more end caps 195 can be provided with appropriate openings for the hooks and bungee cord to be received therein.

The fabric cover 125 can be of any suitable construction but is typically fabricated from a lightweight synthetic fiber, such as nylon. In one embodiment, the fabric is aluminized to give the fabric a reflective silver appearance thereby increasing its ability to reflect heat. Preferably, the fabric has a weight of about 2-3 ounces per square yard and is at least partially breathable and water-resistant.

Referring to FIG. 3, the fabric cover 125 in a partially folded but unrolled state is illustrated. As shown, a piece of leader fabric 215 is typically attached to the main section 220 of the cover by a sewn seam. The leader fabric piece is longitudinally secured to the exterior surface of the roller 160. The leader piece can be secured to the roller using any suitable means such as but not limited to adhesive bonding, staples or other mechanical fasteners, and/or industrial strength (double) adhesive face tape. When initially unrolled from the cylindrical housing the back portion 230 of the cover fabric is folded over onto a front portion 235 and held in place by one or more strategically placed hook and loop material pieces 225. Of course, other removable fasteners, such as buttons or snaps can be substituted for the hook and loop material. Subsequent to the initial unrolling, the back portion is unfolded rearwardly to cover the top of the associated vehicle's trunk and bumper.

As illustrated, left and right portions 240 & 245 of the fabric cover are folded over a center portion such that the width of the folded cover is less than the width of the cylindrical housing 115 and its associated slot 120. The left and right portions, which when unfolded cover the corresponding sides of the vehicle, are typically re-movably secured in the folded position using hook and loop material. The left and right portions can also include additional folded portions as shown. The proper locations of the fold are printed or otherwise marked on the cover in preferred variations so that a user can easily re-fold the cover prior to retraction thereof. Further, in other preferred variations, a seam 266 is sewn about ½-1 inch in from the second fold for each side and optionally on both folds for each side to create tabs that extend substantially the length of associated folds. Accordingly, a user can use the tabs as handles to assist in the unfolding and perhaps more importantly the refolding of the cover. In some variations the cover fabric comprises a single piece of fabric but in other variations, the cover fabric can comprise several pieces that are sewn, fused, bonded or otherwise joined together. In other embodiments, the seams are designed and sewn in a way that seams at one fold are not riding on seams located at other folds.

Operation of the First Embodiment Vehicle Cover System

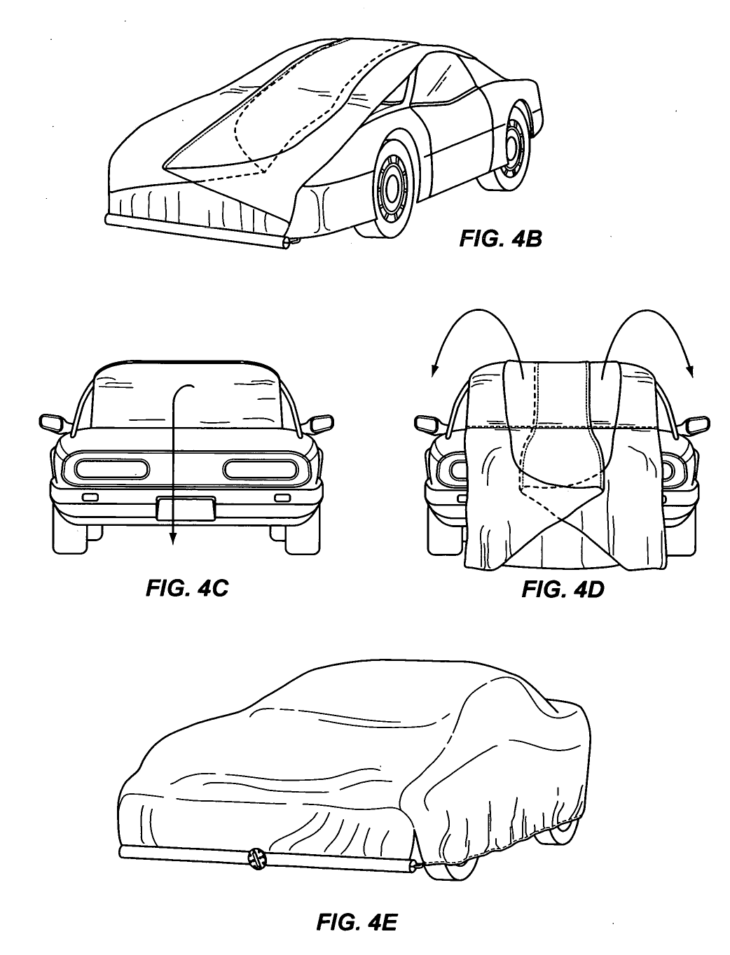

FIGS. 4A-E illustrates the proper and preferred operation of the first embodiment system 100 in conjunction with a sedan type vehicle 105. Typically, although not necessarily, the cover system 100 can be mounted to the ceiling of the vehicles trunk lid 110. The system is typically secured to the lid in the trunk using wing nuts or thumbscrews or even by the means of hose clamps 172. Mounting studs can be attached to the lid ceiling by drilling through an interior layer (or liner) of the ceiling that does not pass through to the trunk's exterior surface. In other variations, studs with flat disk-shaped heads can be adhesively secured or welded to the lid ceiling. Accordingly, a user need only align the appropriate holes in the mounting bracket(s) with the threaded studs, pass the studs through the holes and secure the cover system using one or more threaded nuts or wing nuts. Loosening and removing two (2) nuts is all that is required to facilitate removal of the system from the vehicle. As can be appreciated, the system can be easily transferred and mounted in a second vehicle having similar mounting studs installed therein. Another possible location to mount the cover system is behind the bumper (or in front of the bumper depending on the frame of reference) inside the truck wherein the cover system is located on the trunk floor

It is to be appreciated that the cover system 100 can mounted to the lid of the trunk 110 in various other manners including, but not limited to, the use of installation brackets, pressure sensitive adhesive tape, hose clamps and/or adhesive bonding. Further, instead of threaded stud, appropriately configured threaded nuts can be secured to the ceiling of the trunk lid wherein thumbscrews are used to secure the system brackets to the nuts.

While the illustrated cover system 100 is attached to the lid, it can be attached almost anywhere in the trunk that offers a secure attachment location. Furthermore, as mentioned above, the housing and mounting system can be modified to permit OEM and/or OEM-style mounting inside the rear bumper of a vehicle but allowing access to the guide bar from inside the associated trunk.

To install the fabric cover 125 on the associated vehicle 105, the user first pops his or her trunk lid 110 into its open position. As is typical on almost all sedans, a gap is formed between the front edge of the trunk lid and the bottom of the rear window when the truck is opened. When the lid is fully opened, the guide-bar assembly 130 can be passed therethrough by the user as he/she unrolls a portion of the fabric cover from the roller 160 by depressing the appropriate button on the remote control 190. Next, as illustrated in FIGS. 4A & B, the user moves the guide-bar forwardly over the vehicle's roof and hood towards the front bumper thereby covering most of the top of the vehicle with the folded but unrolled fabric cover.

The user secures the guide-bar assembly 130 to a location typically below the front bumper of the vehicle 105 using the hooks 205. Generally, there are no specific places or locations to which the hooks are secured. Rather, any locations that will receive the hooks and firmly hold the guide-bar in place are suitable.

Next, after closing the trunk lid 110 and as indicated in FIG. 4C, the user unfolds the folded portions 230, 240 & 245 of the cover fabric 125. First, the hook and loop connection pieces 225 for the rear portion 230 are released and the rear portion is folded down over the previously closed trunk and the rear bumper.

As indicated in FIG. 4D, the hook and loop connector pieces 225 holding the left and right side portions 240 & 245 are then released and these portions are unfolded over the sides of the vehicle 105. At this point, the vehicle is completely covered as shown in FIG. 4E.

Finally, in certain variations a drawstring (or perimeter cord) 250 is provided that is thread through grommets or a channel provided proximate the bottom perimeter of the unfolded and deployed cover 125. The drawstring extends continuously around the perimeter beginning and terminating at or proximate the guide-bar assembly 130. A means for pulling the draw string taut is provided so that the user may tighten the bottom perimeter around the base of the vehicle 105. The means can include a spring-biased coupler wherein the user merely pushes the end of the coupler inwardly to release the cords threaded therethrough and then pulls the ends of the draw string taut. Alternatively, the means can comprise a crank coupled to an uptake spool as described in greater detail below with reference to the motorcycle embodiment of the cover system wherein the user first releases the crank, turns it clockwise (or vice versa) to wind the cord on the associated spool and then re-secures the crank so that the string will not unwind.

The user may desire to draw the cover 125 taut on the vehicle body. To do this he/she simply depresses the retract button on the remote 190 for a short period of time to pull the leader piece 215 onto the roller 160 and thereby pull the cover towards the housing slot 120 as well. This may be done prior to closing the trunk lid 110 and before unfolding the rear and side portions of the cover or if there is a large enough gap between the trunk lid and the vehicle body than it can be performed after the lid is closed and the side and rear portions are deployed. If a user desires a measure of hail protection from the cover he can place spacers (not shown) that are typically 1-3″ tall between the generally horizontal surfaces of the vehicle and the bottom surface of the fabric cover and then use the remote to tighten the cover. Accordingly, hail impacting the cover will “trampoline effect” away from the vehicle's metal surface or at least have its velocity slowed before it impacts the car.

To retract and store the cover 125 after it has been deployed; the user first releases the draw string 250 (if the associated embodiment is so equipped) and then loosens the cinched perimeter of the fabric cover. Next, the sides 240 & 245 of the cover are folded upwardly and over the top portion of the cover and the corresponding pieces of hook and loop material are secured to each other. At this stage, the cover should resemble the cover as illustrated in FIG. 3. The back portion 230 is folded upwardly and over the front portion 235 with the fold line located proximate the intersection of the main section 220 of the fabric cover with the leader piece 215. The associated pieces of hook and loop material pieces 225 are secured to each other.

After the fabric cover 125 has been folded, the user releases the hook 205 of the guide-bar assembly 130 from the front of the vehicle and while holding the guide-bar assembly depresses the retract button on the remote control 190. As necessary the user can stop and/or reverse the feed of the fabric cover into the cylindrical housing 115 to ensure the fabric is being wound properly. When the user reaches the gap between the vehicle (rear windshield) and the trunk lid the guide-bar assembly is passed there through and retraction is continued until the guide-bar is received up against the slot 120 in the cylindrical housing 115. Finally, the trunk lid 110 is closed.

It is to be appreciated that in one variation of the first embodiment, the cover can be fully deployed or retracted in less than two minutes.

A Second Embodiment Vehicle Cover System

Referring to FIG. 5, a second embodiment vehicle cover system 300 configured to cover the windows and roof of the associated vehicle 305 to shield the vehicle's interior from the rays of the sun is illustrated. Generally, except for the fabric cover 310 itself and the system's dimensions, it is substantially similar to the first embodiment and is utilized in a similar manner albeit to cover only the windowed surfaces and the roof of the vehicle opposed to the entire vehicle. In one variation, the system fully retracted takes up only 375 cubic inches of volume in the trunk of a vehicle.

The primary difference in the fabric cover 310 and the fabric cover 125 of the first embodiment is the cover's size. It is typically configured to cover only the top portion of the vehicle that includes windows. Another difference is that the bottom perimeter draw string of certain variations of the first embodiment is eliminated. Spring (or bungee cord) loaded clips/hooks 307 are provided at the ends of the guide bar and the rear corners of the cover for attachment to the front and rear fender wheel wells respectively. Additionally, magnets 315 or some other type of fastening device can be provided along the perimeter of the cover to prevent the sides of the cover from blowing off the vehicle when deployed. The magnets can be sewn into the cover around its perimeter at strategic locations or they may be separately provided to be placed in pouches located proximate the perimeter at the time of deployment. Alternatively, hook and loop pieces could be attached to the perimeter of the cover with the corresponding mating pieces attached to the appropriate locations of the vehicle.

A Third Embodiment Vehicle Cover System

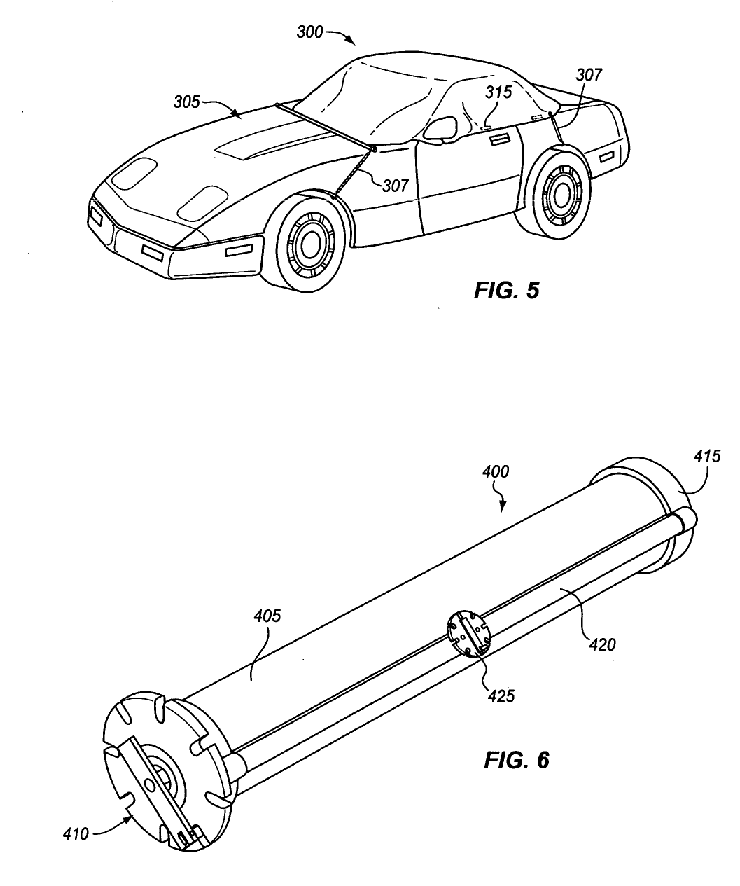

Referring to FIGS. 6-8, a third embodiment vehicle cover system 400 configured to cover a motorcycle (not shown) is illustrated. This embodiment is generally similar in appearance to the first and second embodiments but unlike both of the previously described embodiments, this embodiment is manually operated. Further, this embodiment is designed to mount on a motorcycle license plate mounting bracket. The cylindrical housing 405 is also significantly shorter than the automobile based cover systems. In one variation, the system fully retracted takes up only 180 cubic inches of volume behind the motorcycle seat or at the license plate location. Perhaps the most significant visual difference is the incorporation of a hand crank assembly 410 on one end of the housing.

Internally, the tubular motor and roller of the previous embodiments are replaced with a single roller (not shown) constructed of plastic, metal, wood or another suitable material. The roller is rotatably coupled to the housing 405 on either end of the system 400. The roller is further attached the rotational section of the hand crank assembly 410 via a shaft 442 on the one end. An end cover 415 is provided on the opposite end. The fabric cover is attached to the roller in a similar manner as the described above for the motorized embodiments. Like the above embodiments a leader piece can be utilized.

The leading edge or front end of the fabric cover is attached to the guide-bar assembly 420 in a similar fashion as described above. Unlike the guide-bar assemblies of the other embodiments, no remote control is provided and depending on the variation handles may or may not be provided. As illustrated, a second crank assembly 425 is provided proximate the center of the guide-bar although it can also be placed closer to one end or another as well. The second crank assembly is coupled to a spool contained in the hollow interior of the guide-bar wherein a drawstring that extends around the perimeter of the fabric cover terminates. Accordingly, a user can cinch the cover around the bike by turning the hand crank of the second hand crank 430 assembly. The construction and operation of the second crank assembly is generally similar to the first hand crank assembly save for its more diminutive size.

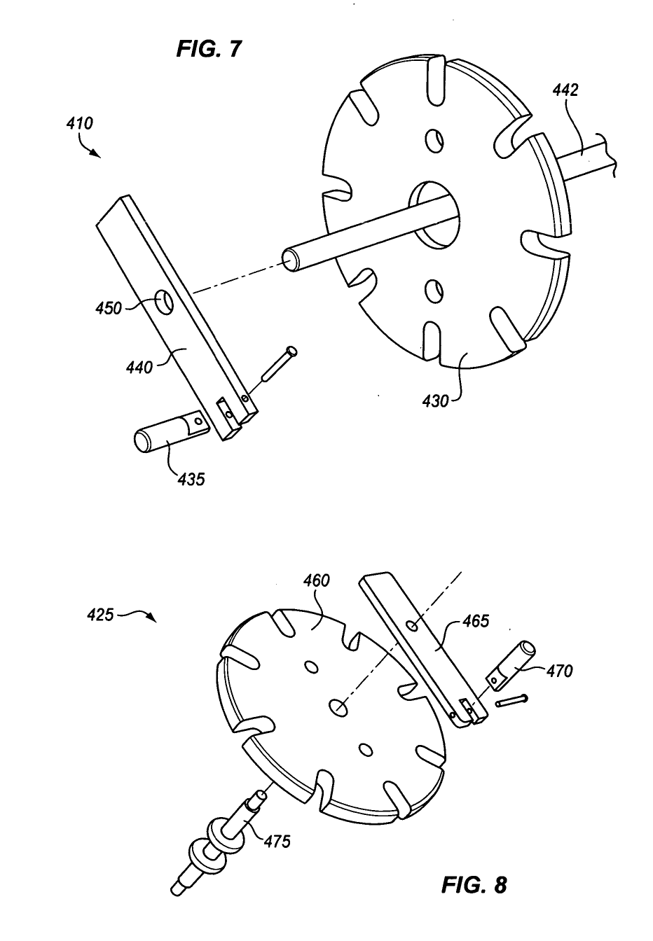

The hand crank assembly 410 as illustrated in FIG. 7 includes a notched wheel plate 430 that is fixedly secured to the cylindrical housing 405 or associated end cover. As the name indicates the plate includes a plurality of notches distributed over its circumference. The notches are sized to receive a handle 435 of a crank arm 440 therein. The handle is pivotally coupled with the end of the crank arm such that it can be rotated from a down position wherein the handle is received into an adjacent notch of the wheel plate thereby preventing the crank arm and consequently the associated roller from rotating. Further, by pivoting the handle out of a notch, the crank arm, its associated shaft 442 and the roller are freed for rotational movement as is required to unroll or retract the fabric cover. As shown, the crank arm 440 includes a hole 450 into which one end of the shaft is fixedly received.

The second crank arm assembly 425 like the first crank arm assembly includes a wheel plate 460, a crank arm 465 and an associated pivotal handle 470. The wheel plate is fixedly secured to the guide-bar. The crank arm is rotatably coupled to a spool 475 that extends into the interior of the guide-bar assembly around which an associated drawstring is wound.

To deploy the fabric cover of the motorcycle cover system 400, a user releases the pivotal handle 435 from the corresponding notch in the wheel plate 430 by pivoting it about 180 degrees. This action effectively unlocks the roller. Next, user pulls the fabric cover by way of the guide-bar assembly 420 over and towards the front end of the motorcycle while unrolling the cover material from the housing. Depending on the design of the guide-bar assembly hook or other attachment means may be provided to secure the guide-bar assembly to the bike's front wheel. The cover is unfolded in much the same fashion as described above for an automobile. Finally, the user releases the second hand crank assembly 425 and rotates it clockwise (or counterclockwise) to tighten the draw string that extends around the bottom perimeter of the cover. Finally, the user pivots the second crank's handle 470 into a corresponding notch in its wheel plate 460 to secure it and the draw string in place.

To retract the cover, the user first releases the handle 470 of the second crank arm assembly 425 and pulls the draw string from the associated spool 475. Next, he/she folds the cover at the indicated seams so that its width is not greater than the width of the slot in the cylindrical housing 405. If not already in the released position, the user pivots the handle 435 of the first crank arm assembly 410 out of an adjacent notch. Holding the handle, the user rotates the handle counterclockwise to pull the cover into the housing's slot and roll it on the associated roller. The cover is completely retracted when the guide-bar assembly is pulled up against the slot. To secure the cover in the retracted position the handle is pivoted downwardly into an adjacent notch in the wheel plate.

A Fourth Embodiment Vehicle Cover System

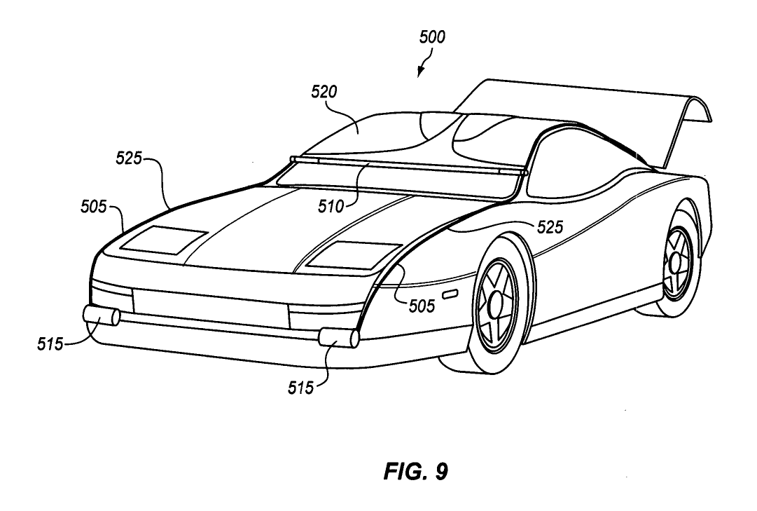

The fourth embodiment vehicle cover system 500 is designed into be incorporated as an OEM option in an associated automobile. An automobile 105 with the fabric cover of the system partially deployed is illustrated in FIG. 9. This embodiment automatically deploys and retracts the cover once properly folded without the user of the automobile having to guide the cover as with the previous embodiments. The primary differences between this embodiment and the first embodiment include a pair of guide wires/cables 505 that are attached to either end of the guide-bar assembly 510 at one end and are attached to one or more motorized spool assemblies 515 typically incased and located under the front bumper of the associated vehicle. The spool motors of the motorized spool assemblies, as well as, the tubular motor in the cylindrical housing include wireless receivers that interface with a provided remote control. Accordingly, when a user depresses a “deploy” button on the remote the spool motors are activated to deploy the fabric cover 520.

As illustrated, the cover extends from the gap between the trunk lid 110 and the body of the car. Accordingly, the user might be required to open the trunk before deploying the cover. Alternatively, since this embodiment is intended to be an OEM installation, the trunk may be popped open automatically when the user depresses the deploy button. In other variations, the cover system can be mounted in the rear bumper (or even the front bumper) wnerein opening the trunk is not required.

The cables 505 for the motorized spool assemblies preferably run in eyelets that are confined in recessed tracks 525 provided in the associated vehicle, such as the rain gutters of most new vehicles. It is appreciated that the spool assemblies will typically also include clutches, such as a magnetic clutch that releases when the cover is being retracted to allow the cables to unwind freely.

The user will typically unfold the rear portions and side portions of the cover once the cover has been deployed over the top of the car. Further, the user would fold the cover before retracting the cover back into its housing in the trunk.

Alternative Embodiments and Variations

The various embodiments and variations thereof illustrated in the accompanying Figures and/or described above are merely exemplary and are not meant to limit the scope of the invention. It is to be appreciated that numerous variations of the invention have been contemplated as would be obvious to one of ordinary skill in the art with the benefit of this disclosure.

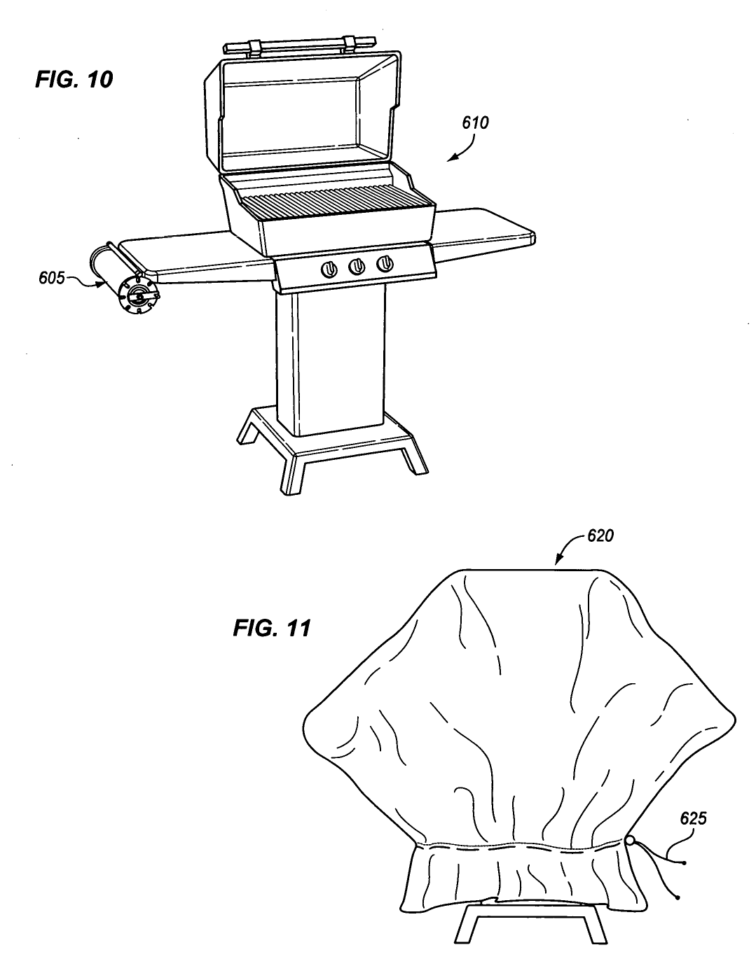

For instance, although the invention and the foregoing embodiments are described primarily in relation to use with a motor vehicle, it is appreciated that the cover system can also be used with other items, such as but not limited to barbecue grills, air conditioner units, bicycles, and evaporative coolers to name a few. FIGS. 10 & 11 are illustrations of a cover system 605 suitable for use with a barbecue grill. As shown in FIG. 10, the manually-operated cover system is mounted to a side tray of the grill 610. As shown in FIG. 11, the grill is covered by the cover fabric 620 and a draw string 625 proximate the bottom perimeter of the cover fabric is cinched to hold the cover in place on the grill.

I claim:

1. A cover system comprising:
a roller having a first length;
mounting brackets rotatably coupled with the roller for mounting the cover system to an item to be covered;
a fabric cover (i) having a first width greater than or equal to the first length when in an unfolded configuration, (ii) having a second width equal to or less than the first length when in a folded configuration, (iii) including a plurality of connectors distributed on surfaces of the cover to maintain the cover in the folded configuration, (iv) including one or more sewn seams proximate one or more fold lines to create one or more tabs, each tab extending at least a substantial portion of a length of an associated fold and (iv) being coupled to the roller; and
a guide-bar coupled to an end of the fabric cover. The seams in fabric will cross each other but will not ride on each other when roll in the housing.

2. The cover system of claim 1, wherein the roller is contained in a hollow housing, the housing including a lengthwise slot, the lengthwise slot having a length equal to or greater than the second width, the hollow housing being fixedly coupled to the mounting brackets.

3. The cover system of claim 1, wherein the roller comprises an electric tubular motor and wherein the cover system further includes a wireless receiver, the wireless receiver being operatively coupled to the tubular motor and being adapted for receiving signals from an associated remote control transmitter.

4. The cover system of claim 1, wherein the roller is at least partially hollow and further comprises a tubular motor substantially contained within the roller.

5. The cover system of claim 1, wherein the plurality of connectors comprise pieces of hook and loop material.

6. The cover system of claim 1, further including a drawstring extending around a perimeter of the fabric cover.

7. The cover system of claim 1, wherein the guide-bar is substantially hollow, and a hook of a pair of hooks extending from each end of the guide-bar, the hooks being attached to an elastic cord or spring, the elastic cord or spring is being substantially contained in the guide bar.

8. The cover system of claim 1, wherein the fabric cover includes a main section adapted to cover a vehicle and a leader piece that extends between the main section and the roller.

9. In combination, the cover system of claim 1 mounted to one of the group including: a barbeque grill; an air conditioner unit; an evaporative cooler unit; and a bicycle.

10. In combination, the cover system of claim 1 mounted to a motor vehicle.

11. The combination of claim 10, further comprising one or two spool motors attached proximate a front end of the motor vehicle and coupled to the guide bar by way or one or two guide wires, the guide wires substantially concealed in recesses extending from a front edge of the vehicle's trunk, over the vehicle's roof and adjacent the vehicle's hood.

12. In combination a motor vehicle and a cover system, the combination comprising:
the vehicle including a trunk and a trunk lid the trunk lid having (a) a bottom surface facing into the trunk when the lid is closed, and (b) a front edge facing generally towards the front of the vehicle; and the cover system including (i) a roller, (ii) a housing substantially enclosing the roller, the housing including a lengthwise extending slot, (iii) a fabric cover coupled to the roller with at least a portion extending through the slot, and (iv) a guide-bar coupled to one end of the fabric cover;
wherein the cover system is mounted in a trunk of the motor vehicle.

13. The combination of claim 12, wherein a tubular motor is substantially contained within the roller, and the cover system further includes a wireless receiver and a remote control adapted for controlling the operation of the tubular motor.

14. The combination of claim 12, wherein (1) the slot faces generally towards the front of the vehicle, and (2) the guide-bar is adapted to fit and pass between a gap formed between the front edge of the trunk lid and a corresponding adjacent edge of the vehicle's rear windshield when the lid is open.

15. The combination of claim 12, wherein the fabric cover includes a folded configuration with side portions folded on top of a center portion and a rear portion folded over onto a front portion along predefined fold lines, the fabric cover being rolled onto the roller in the flat folded configuration.

16. The combination of claim 12, wherein the cover system further comprises a plurality of hook and loop pieces distributed on the fabric cover for securing the cover in the folded configuration.

17. A method of deploying a vehicle cover, the method comprising:
opening a trunk lid of a motor vehicle;
passing a guide-bar attached to a fabric cover through a gap between a front edge of the trunk lid and an edge of the vehicle body at the rear windshield and pulling the fabric cover therethrough;
guiding the guide-bar and attached cover fabric over the top of the vehicle; and
securing the guide-bar to a location under a front bumper of the vehicle.

18. The method of claim 17, further comprising mounting a vehicle cover having the guide bar and the fabric cover in the trunk of the motor vehicle using two thumb screws or wing nuts.

19. The method of claim 17 further comprising:
closing the trunk;
unfolding a back portion of the fabric cover to cover the rear section of the vehicle; and
unfolding left and right side portions of the fabric cover to cover the left and right sides of the vehicle.

20. The method of claim 19 further comprising:
cinching a drawstring to tighten the bottom perimeter of the fabric cover around the vehicle.
